(19) United States
(12) Patent Application Publication
(10) Pub. No.: US 2010/0283673 A1
(43) Pub. Date: Nov. 11, 2010

(54) Signal processing techniques for improving the sensitivity of GPS receivers

(75) Inventors: Farrokh Farrokhi, San Ramon, CA (US); Dickson T. Wong, Burlingame, CA (US); Arthur J. Collmeyer, Incline Village, NV (US)

Correspondence Address: Arthur J. Collmeyer;c/o etherWhere Corp., 811 Guinda Street, Palo Alto, CA, 94301, US

(73) Assignee: etherrWhere Corporation

(21) Appl. No.: 12/587,096

(22) Filed: Oct. 2, 2009

Related U.S. Application Data
(63) Continuation-in-part of application No. 12/387,888, filed on May 9, 2009.
Application No. 12/387,888 is a continuation-in-part of application No. 12/387,889, filed on May 9, 2009.

(51) Int. Cl. G01S 19/42; G01S 19/09

(52) U.S. Cl. 342/357.25; 342/357.46

(57) ABSTRACT

A system for measuring the pseudo range from a target GPS sensor to a designated navigational satellite, for use in a satellite positioning system (SPS) is comprised of multiple GPS sensors for receiving and recording portions of the signals transmitted by designated navigational satellites, the recordings referred to as datagrams; and means for transmitting the datagrams to a datagram processing facility wherein the pseudo range from the target GPS sensor to the designated navigational satellite is derived. The datagram processing facility for deriving the pseudo range is further comprised of a pseudo range engine for deriving a pseudo range from a datagram originating with said target GPS sensor, the location of which is to be determined, the derivation accomplished with the aid of a perfect reference; a perfect reference engine for generating a perfect reference from one or more satellite-specific datagrams: and a strong signal suppression engine for synthesizing satellite-specific datagrams from I/F signals recorded by reference GPS sensors designated for the express purpose of perfect reference generation. The perfect reference reduces the minimum signal strength required to acquire and accurately track GPS satellites at or near the horizon.

### CROSS-REFERENCE TO RELATED APPLICATIONS

This application is a continuation-in-part of, and claims priority under 35 U.S.C. ξ 120 from pending U.S. patent application Ser. Nos. 12/387,888 and 12/387,889, entitled “Signal Processing Techniques for Improving the Receive Sensitivity of GPS Receivers” filed on May 9, 2009, the subject matter of each of which is incorporated herein in its entirety. This application further claims priority under pending U.S. patent application Ser. No. 12/220,612, entitled “Method and Apparatus for Determining Location” filed on Jul. 25, 2008, the subject matter of which is incorporated herein in its entirety.

### STATEMENT REGARDING FEDERALLY SPONSORED RESEARCH OR DEVELOPMENT

Not Applicable

### BACKGROUND OF THE INVENTION

This invention relates to the determination of location coordinates of devices embodying GPS sensors.

The NAVSTAR Global Positioning System (GPS) developed by the United States Department of Defense uses a constellation of between 24 and 32 Medium Earth Orbit satellites that transmit precise microwave signals, which allows devices embodying GPS sensors to determine their current location. The initial application was predominantly for military purposes, namely weapons targeting and troop deployment. The first widespread consumer based application was navigational assistance. These early applications shared similar operating conditions in that the GPS navigational devices (also called GPS receivers) were (1) used outdoors, and (2) co-located with the end-user. Because of the requirement for mobility, GPS receivers were typically battery-operated devices, with power consumption a critical design consideration.

Today, a new wave of applications is emerging, requiring a wider operating environment, including indoor operation. The major sectors include, government and safety—(emergency location and E-911 services), enterprise and industrial (asset tracking and monitoring), and consumer (location based services). Because current GPS processing techniques are unable to provide the receive sensitivity required for reliable indoor operation, these applications have developed slowly. The major factors impacting indoor and “urban canyon” operation of GPS receivers are (1) path losses due to obstructions between the GPS satellites and the GPS receiver, (2) multi-path fading of the incoming GPS signal, and (3) the requirement to obtain pseudo ranges for a minimum of four GPS satellites in order to determine the three dimensional coordinates of the GPS receiver.

The signals from all the GPS satellites are broadcast using the same carrier frequency, 1.57 GHz in the case of the NAVSTAR system. However, each satellite has a unique identifier, or pseudorandom noise (PRN) code having 1023 chips, thereby enabling a GPS receiver to distinguish the GPS signal from one GPS satellite from the GPS signal from another GPS satellite. In addition, each satellite transmits information allowing the GPS receiver to determine the exact location of the satellite at a given time. The GPS receiver determines the distance (pseudo range) from each GPS satellite by determining the time delay of the received signal. The pseudo range information includes a local time offset to each GPS satellite from the time-of-arrival of the PRN code, the Zcount and ephemeris parameters in the GPS signal that it receives from that GPS satellite. The determination of three-dimensional location coordinates can be accomplished with as few as three satellite pseudo ranges, provided they are measured using a time reference. Since this is impractical with current GPS navigational platforms, the computation of location coordinates is generally accomplished using four pseudo ranges. This is illustrated in FIG. 1, where pseudo range information 15, 16, 17, 19 is used to determine the location coordinates of GPS receiver 10. Once the pseudo ranges for at least four GPS satellites have been determined, it is a straightforward process to determine the location coordinates of the GPS receiver.

FIG. 2 describes the data structure of the signal that is broadcast by each GPS satellite, where the signal contains 50 Hz data overlay signal—20 millisecond data bits modulating a one millisecond PRN code interval of 1023 bits or chips. The PRN code is known as a spreading code because it spreads the frequency spectrum of the GPS signal. This spread spectrum signal is known as a direct sequence spread spectrum (DSSS) signal.

Indoors, satellite signals suffer severe path losses as they are forced to penetrate windows, walls, and ceilings enroute to the receiver. Commercial buildings, in particular, introduce severe path losses (FIG. 3). Along the vertical, the roof and each intermediate floor contribute losses of estimated at 30 db. Exterior walls provide an estimated loss of 20 db, with interior walls adding 5 db each. Clearly, the indoor environment favors satellites near the horizon (over those directly above).

Indoors, and in urban canyons, the satellite signals reach the receiver by multiple paths. The result is a signal that is the composite of multiple instances of the transmitted signal, each reduced in power and differentially delayed. Absent the ability to isolate and recombine these reflected signals, the sensitivity of a receiver is effectively reduced. In strong signal communications applications, adaptive equalization techniques have been employed to combat the effects of multi-path—to prevent, for example the destructive combination of multiple instances of the transmitted signal, delayed relative to each other. To date, no such technology has been developed for applications in which the signal is buried in noise, such as satellite positioning. So, whereas a GPS receiver out in the clear is likely to see a single instance of a given satellite transmission, indoors the receiver is likely to see multiple variously-attenuated instances, delayed relative to each other, as shown in FIG. 4. The impact of this can be confounding to the prior art GPS receivers described in the paragraphs which follow.

FIG. 5 illustrates a block diagram of a prior art GPS receiver. The GPS signal from GPS satellite constellation 56 is received by the R/F front end 51 of GPS receiver 50. R/F front end 51 down converts the 1.57 GHz R/F signal, resulting in an intermediate frequency (I/F) signal. The streaming I/F signal is examined by a correlator or bank of correlators 52, employing a search algorithm to confirm the presence or absence, within the composite GPS signal, of component signals from the GPS satellites. In a typical search algorithm, the local frequency 53 is scanned across a range of frequencies; for each frequency, a series of correlations involving the incoming GPS signal and all possible code phases of a local replica 54 of the designated satellite's PRN code are used to “acquire” the designated satellite (i.e., determine the presence or absence of the designated satellite signal within the composite GPS signal). In order to ensure that the correct code phase is not missed due to local clock off-set, it is conventional to increment the local replica code phase in one-half chip or even smaller steps. The granularity of these steps is limited by the amount of over sampling that is performed on the incoming I/F signal. A high correlation peak value indicates that the designated satellite is present, and its signal, decodable. If no correlations peaks are high enough, the local frequency 53 is set to a second trial frequency and the correlations are repeated. Once pseudo range information has been obtained for at least four GPS satellites along with the corresponding satellite timing information, the coordinate generator 55 determines the three-dimensional location coordinates of the GPS receiver 50. There are a number of drawbacks to this approach, including a long time to first fix (TTFF) and reduced receive sensitivity in certain situations (e.g., those involving severe path loss).

To obtain a first fix, GPS receiver 50 must (1) acquire a minimum of four GPS satellites (three if a 2D fix is acceptable), by tuning the local frequency 33 and the code phase of the local PRN code replica 34 in the GPS receiver to match the carrier frequency and the PRN code phase of each of the electronically visible (i.e., decodable) satellites. The search for correlation peaks of sufficient strength to enable the extraction of reliable pseudo range information is a time-consuming process in general, and failure-prone in indoor and urban canyon environments.

To minimize the TTFF of GPS receivers such as GPS receiver 50, the concept of a GPS assistance system has been introduced (see FIG. 6). The role of GPS assistance system 69 is to track, the satellites electronically visible at the site of GPS assistance system 69, and provide assistance, in the form of carrier frequency and phase as well as PRN code phase information to GPS receiver 60 in the vicinity of GPS assistance system 69. As in the case of GPS receiver 50, the GPS signal from GPS satellite constellation 66 is received by the R/F front end 61 of GPS receiver 60. R/F front end 61 down converts the 1.57 GHz R/F signal, resulting in an intermediate frequency (I/F) signal. The streaming I/F signal is examined by a correlator or bank of correlators 62, which is used to acquire satellites. To expedite the acquisition process, carrier frequency and phase as well as PRN code phase information derived by GPS assistance system 69, in the course of tracking acquirable satellites, is transmitted to GPS receiver 60. This information is used to initialize the search algorithm, enabling the algorithm to operate more efficiently and more effectively. As a result the TTFF is significantly reduced, and receive sensitivity is improved marginally, to the extent that information provided enables the acquisition of satellites otherwise electronically invisible (that is to say, their signals are not decodable) to GPS receiver 60. Once pseudo range information has been determined for four GPS satellites, the location coordinates are determined by coordinate generator 65.

As discussed earlier in the context of FIG. 3, satellites at or near the horizon are apt to be among the most electronically visible to GPS receiver 60 when indoors or in an urban canyon. To provide accurate and effective information to GPS receiver 60 under these circumstances, it is critical that GPS assistance system 69, provide accurate carrier frequency and phase as well as PRN code phase information for satellites at or near the horizon, notwithstanding the challenge implicit in the acquisition and tracking of weak satellite signals in the presence of strong satellite signals.

The potential for strong satellite signals to interfere in the tracking of weak satellite signals is an artifact of the correlation process which serves as the foundation for GPS satellite signal acquisition and tracking techniques. This is illustrated in FIGS. 7-9. FIG. 7 describes the output of the correlation of the composite GPS satellite signal with the PRN code for weak satellite A, as it would appear if all other GPS satellites were turned off. A distinct peak in the correlator output marks the presence of (a signal from) satellite A. In FIG. 8, strong satellite B has been turned on, and the output of the correlator has changed, revealing prominent cross correlation peaks owing to the relative strength of (the signal from) satellite B. In FIG. 9, a second strong satellite C has been turned on, adding additional prominent cross correlation peaks to the correlator output.

As the figure illustrates, the search for the autocorrelation peak corresponding to weak satellite A is complicated if not completely frustrated by the prominent cross correlation peaks introduced by the strong satellites B and C. Under these circumstances, a GPS assistance system may be unable to provide useful information on weak satellite A to target GPS receivers in its vicinity. On its surface, this does not appear to be a serious limitation: “How important can it be to provide assistance in the acquisition of weak satellites, especially if the strong satellite information is accurate?”

The answer to this question depends, of course, on the circumstance of the target GPS receiver. When the target receiver is indoors, especially on the lower floors of a multi-story commercial building, this information is likely to be critical, as the only satellites acquirable may be those near the horizon, the same satellites that are likely to have been compromised by stronger overhead satellites at the site of the GPS assistance system.

Since neither GPS receiver 50 nor GPS receiver 60 has demonstrated the capability of providing reliable indoor and urban canyon operation, there is a need in the art for a method of improving the receive sensitivity of GPS-enabled devices, consistent with the requirements of the emerging E-911, asset management, and location-based consumer applications.

### BRIEF SUMMARY OF THE INVENTION

In general, the object of the present invention is to provide methods and apparatus to increase the receive sensitivity of GPS receivers in order to provide for the reliable determination of location coordinates in indoor and urban canyon operation. To this end, novel signal processing techniques reducing the minimum signal strength required to acquire a satellite in indoor and urban canyon environments are disclosed. The use of multiple GPS sensors provides the conceptual framework for such techniques. In this context, GPS sensors are characterized as one of two types: target GPS sensors, whose location is to be determined; and reference GPS sensors, used in the derivation of a reference used to increase the receive sensitivity of target GPS sensors.

The reduction in the minimum signal strength required to acquire a satellite (characterized as an increase in receiver sensitivity) results from innovations in signal processing, enabled by the rearchitecting of prior art GPS receivers, as described in FIGS. 11 and 14. The repartitioning of the basic functions—opening the signal processing platform to sophisticated techniques—enables the signal processing innovations essential to achieving the improvements in receive sensitivity required for reliable indoor and urban canyon operation.

As shown in FIG. 11, the invention postulates the embedding of simple target GPS sensors 111 with mobile devices that either host or serve as peripherals in location-based applications. These target GPS sensors receive and record signals transmitted by navigational satellites, and forward their recordings (datagrams) to a Datagram Processing Facility. The invention further postulates a set of one or more reference GPS sensors 112 and 113 embedded in devices deployed for the purpose of providing the Datagram Processing Facility reference datagrams useful in extracting the pseudo range information critical to determine the location of mobile devices.

The reference GPS sensors may be stationary or mobile. The presumption is, however, that they are stationary, in known locations, and positioned for unobstructed reception of satellite signals. Accordingly, positioning accuracy based on pseudo ranges measured at these reference GPS sensors can be further improved through a reconciliation of their measured location with their known location to correct for atmospheric effects, as is done with WAAS data.

The Datagram Processing Facility 114 processes datagrams from target and reference GPS sensors, in order to extract the information essential to determine the location of the target sensor. In general, one target datagram and one or more reference datagrams, overlapping at least partially in time, are used to determine the location. In the event there are multiple reference GPS sensors, the choice of which of the reference sensors/datagrams to use is made by the Datagram Processing Facility 114. To make constructive choices, the Datagram Processing Facility accepts selection cues from target GPS sensors to minimize the remoteness of reference GPS sensors from target GPS sensors. To further inform the selection process, and optimize the efficiency and efficacy of the extraction of pseudo range information from target datagrams, Datagram Processing Facility 114 incorporates a strong signal detection capability, for the purpose of identifying the satellites electronically visible to the target GPS receiver.

With this rearchitecturing of the Satellite Positioning System, a signal processing technique called perfect reference generation has been developed. Perfect reference generation is a novel technique for optimizing the extraction of pseudo ranges from datagrams recorded at target GPS sensors, whether by correlation or by equalization techniques. The perfect reference, extracted from one or more datagrams recorded at one or more reference GPS sensors, designated for the express purpose of perfect reference generation, is a reconstruction of the transmitted signal based on the analysis of large datagrams, enabling the reduction of the minimum signal strength required to acquire and accurately track a satellite.

The Perfect Reference Engine (FIG. 14) extracts the perfect reference from satellite-specific datagrams generated by the Strong Signal Suppression Engine, featuring novel techniques to mitigate the strong signal interference which often compromises the process of acquiring and tracking satellites at or near the horizon, which satellites are frequently the only satellites available to target GPS receivers indoors. As a result the minimum signal strength required to acquire satellites indoors is reduced in most instances.

To leverage the perfect reference when the composite satellite signal at the target GPS sensor is multi-path, as frequently is the case indoors or in urban canyons, the Pseudo Range Engine features a novel adaptation of classic equalization concepts to the case where multi-path signals are buried in noise. With the availability of a perfect reference, the recombination of multi-path signals is reduced to a tractable mathematical formulation. As a result, the minimum signal strength required to acquire and accurately track a satellite is reduced even further.

In accordance with the present invention, a system for measuring the pseudo range from a first GPS sensor to a designated navigational satellite, for use in a satellite positioning system (SPS) is presented, said system comprising:

target and one or more reference GPS sensors for receiving and recording target and one or more reference portions of the signal transmitted by the designated navigational satellite, the recordings hereinafter referred to as the target and reference datagrams;
means for transmitting the target and reference datagrams to a datagram processing facility; and
a datagram processing facility wherein:
a perfect reference is generated from the one or more reference datagrams, and wherein:
the pseudo range from the target GPS sensor to the designated navigational satellite is derived from the target datagram using a signal processing technique employing the perfect reference.

In another embodiment, the one or more reference GPS sensors are stationary GPS sensors designated for the purpose of perfect reference generation.

In accordance with the present invention, a datagram processing facility for extracting the pseudo range from a target GPS sensor to a designated navigational satellite from a datagram originating with said target GPS sensor is presented, said facility comprising:

a pseudo range engine for deriving a pseudo range from said datagram originating with said target GPS sensor, the derivation accomplished with the aid of a perfect reference, and
a perfect reference engine for generating a perfect reference from one or more datagrams originating with one or more reference GPS sensors, designated for the purpose of perfect reference generation.

In accordance with the present invention, a perfect reference engine for generating a perfect reference to facilitate the derivation of a target pseudo range from a datagram originating with a target GPS sensor is presented, said engine comprising:

local replicas of the PRN codes for the GPS satellites;
correlation means for recovering, from a large reference datagram, through iteration over frequency and PRN code phase, the (PRN code specific) 50 Hz bit stream or bit streams implicit in said datagram;
correlation means for deriving, from a large reference datagram, through iteration over frequency and PRN code phase, the (PRN code specific) reference pseudo range or pseudo ranges implicit in said datagram; and
means for reconstructing for each satellite, the transmitted signal, using the recovered satellite-specific 50 Hz bit stream and PRN code replica.

In another embodiment, the perfect reference engine processes large datagrams.

In yet another embodiment, the perfect reference engine generates a perfect reference with carrier frequency and phase and channel compensation.

In accordance with the present invention, a strong signal suppression system for synthesizing GPS satellite-specific I/F signals from the composite GPS satellite signal, enabling more efficient and effective acquisition of said GPS satellites is presented, said system comprising:

multiple reference GPS sensors, each with an omni-directional antenna and front end for down converting composite GPS satellite signals into I/F signals, and
strong signal suppression engine for synthesizing, from the I/F signals produced by said reference GPS sensors, a set of one or more GPS satellite-specific I/F signals, each with one or more of the strongest potentially-interfering GPS satellite signals suppressed, for input to a perfect reference engine.

Those skilled in the art will understand that the strong signal suppression engine, the perfect reference engine and the pseudo range engine may be implemented in mixed signal circuitry, including logic circuits and/or a microprocessor with appropriate software or firmware. Further, those skilled in the art will understand that the methods and apparatus of the present invention may be applied to satellite positioning systems evolved from the GPS satellite positioning system, including but not limited to the Galileo and Glasnost systems.

Various aspects and features of the present invention may be understood by examining the drawings here listed.

### BRIEF DESCRIPTION OF THE DRAWINGS

FIG. 1 shows the system diagram of a GPS satellite positioning system (SPS)

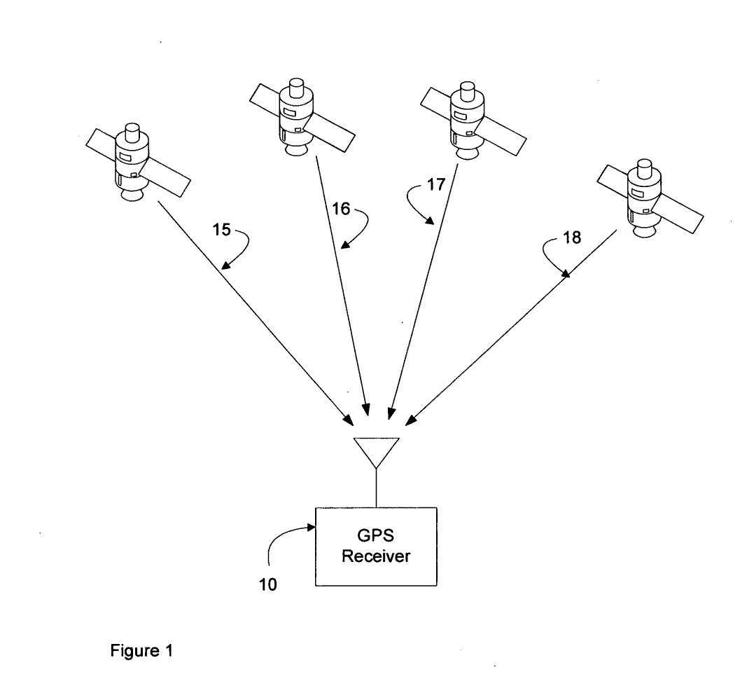

FIG. 2 describes the data structure transmitted by a GPS satellite

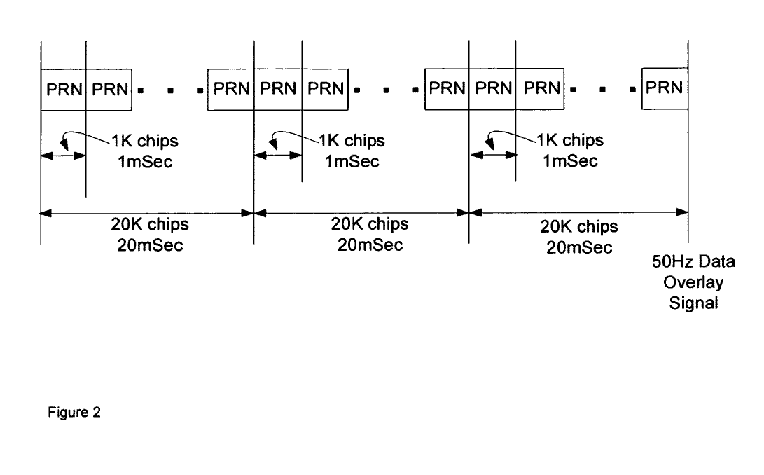

FIG. 3 illustrates the nature of path losses experienced by satellite signals penetrating commercial buildings

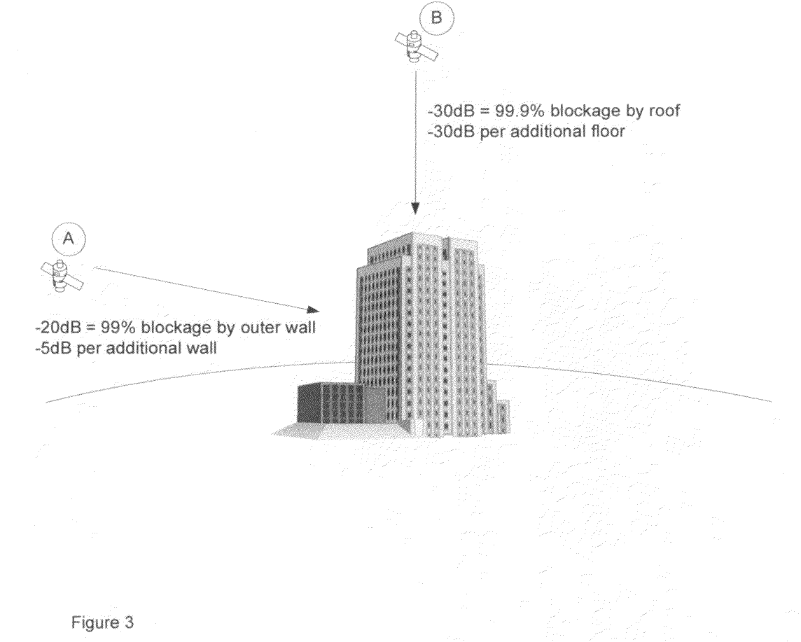

FIG. 4 illustrates the signal degradation resulting from multi-path

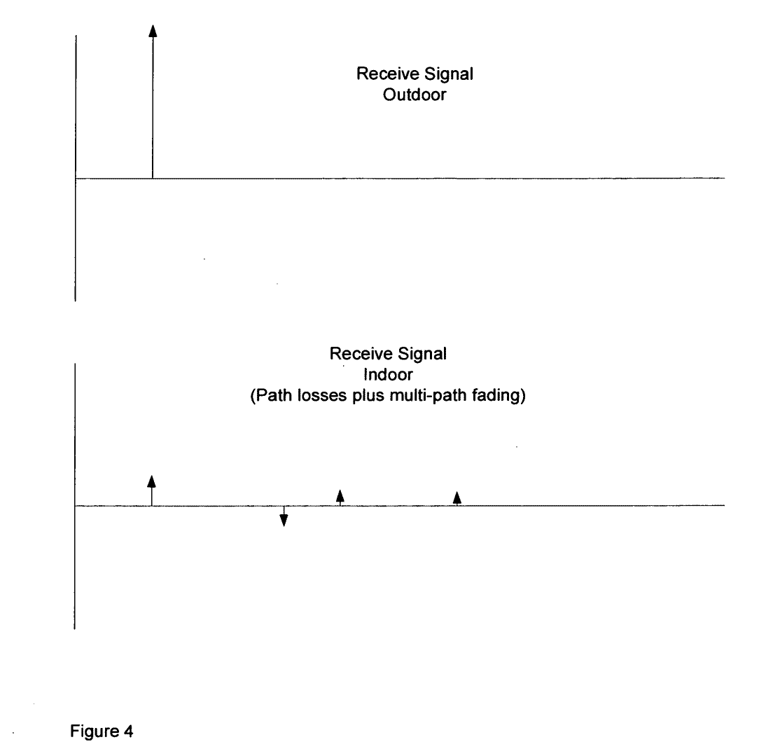

FIG. 5 shows a block diagram of a prior art GPS receiver

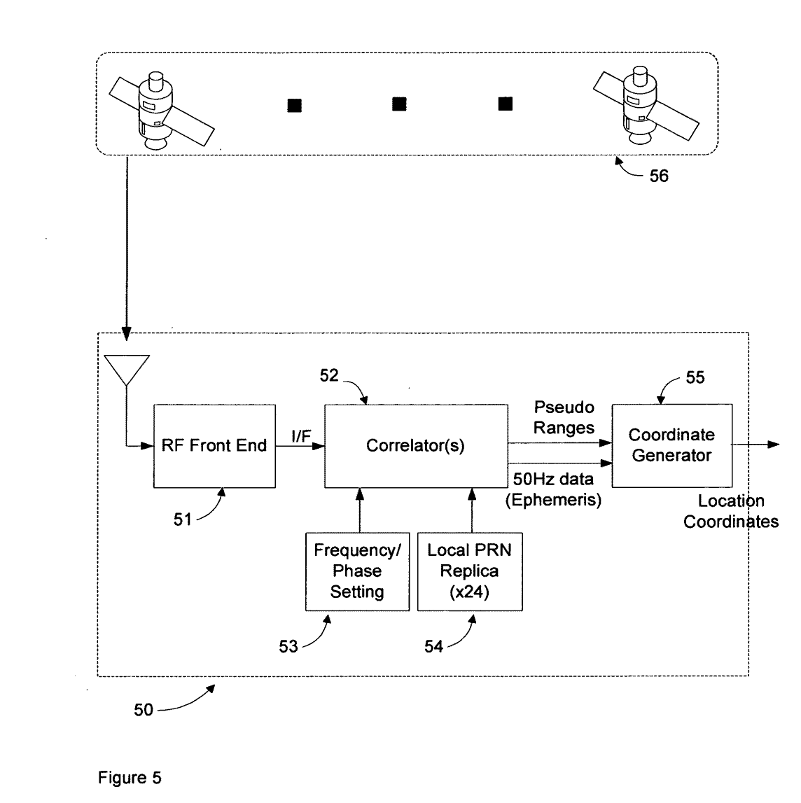

FIG. 6 shows a block diagram of a prior art assisted-GPS receiver

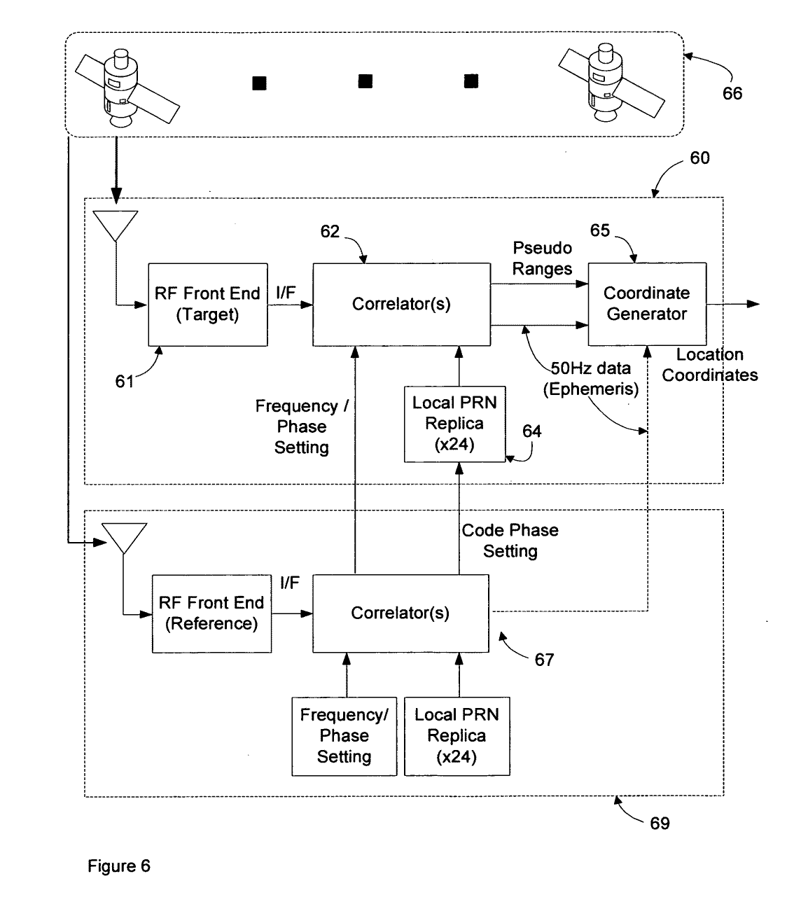

FIG. 7 describes the output of a correlator

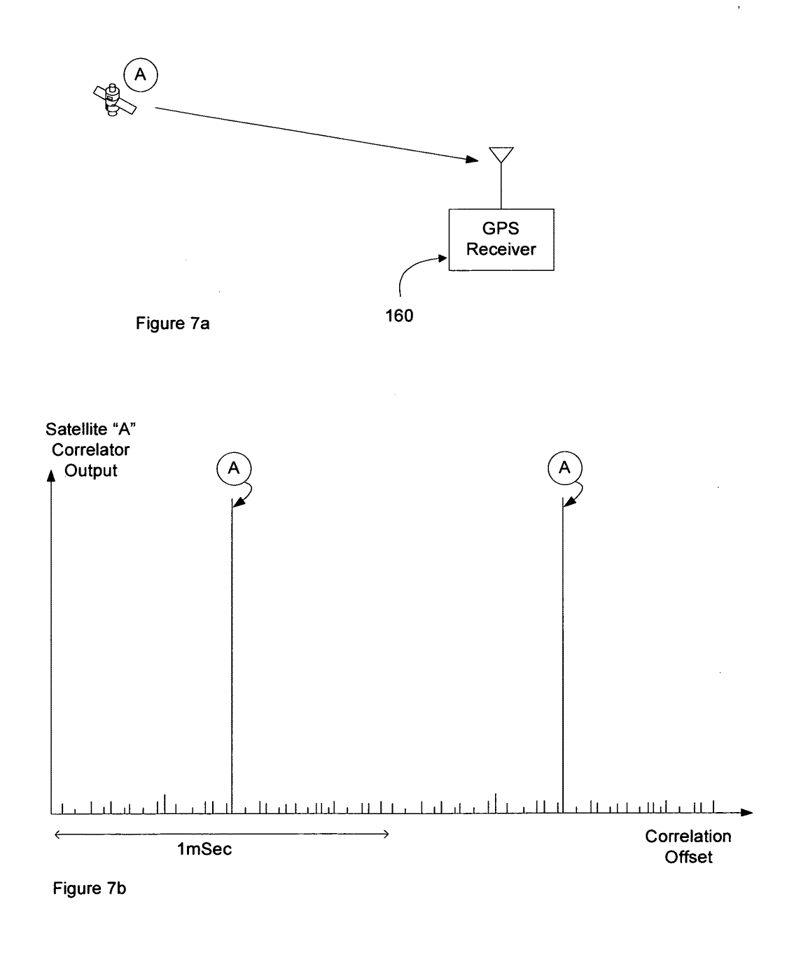

FIG. 8 describes the output of a correlator

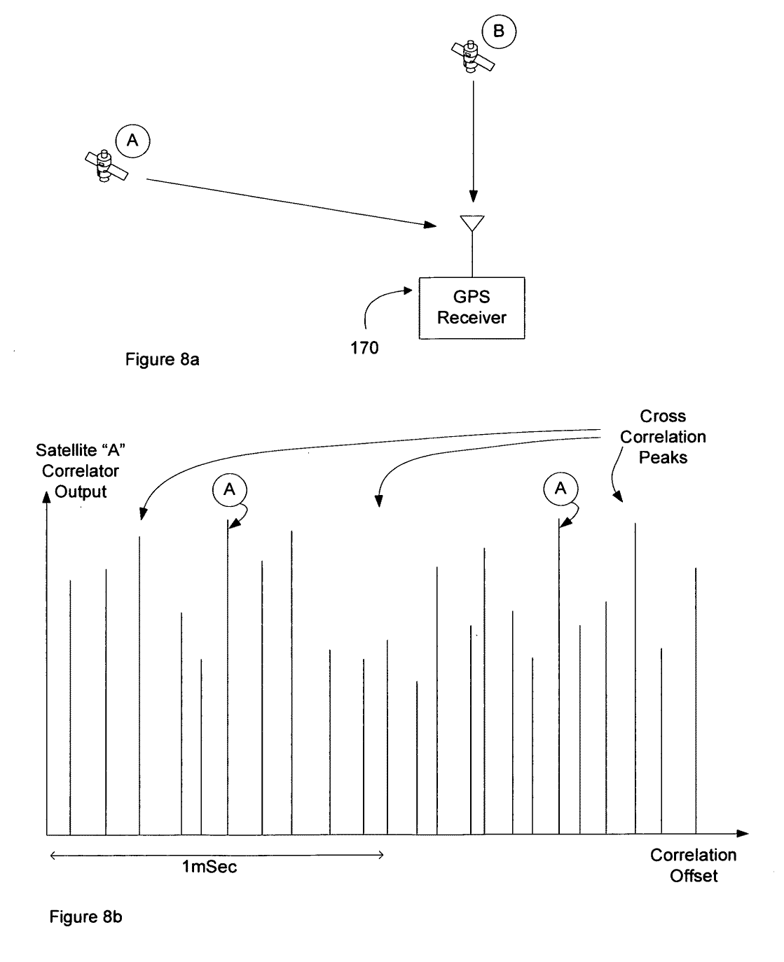

FIG. 9 describes the output of a correlator

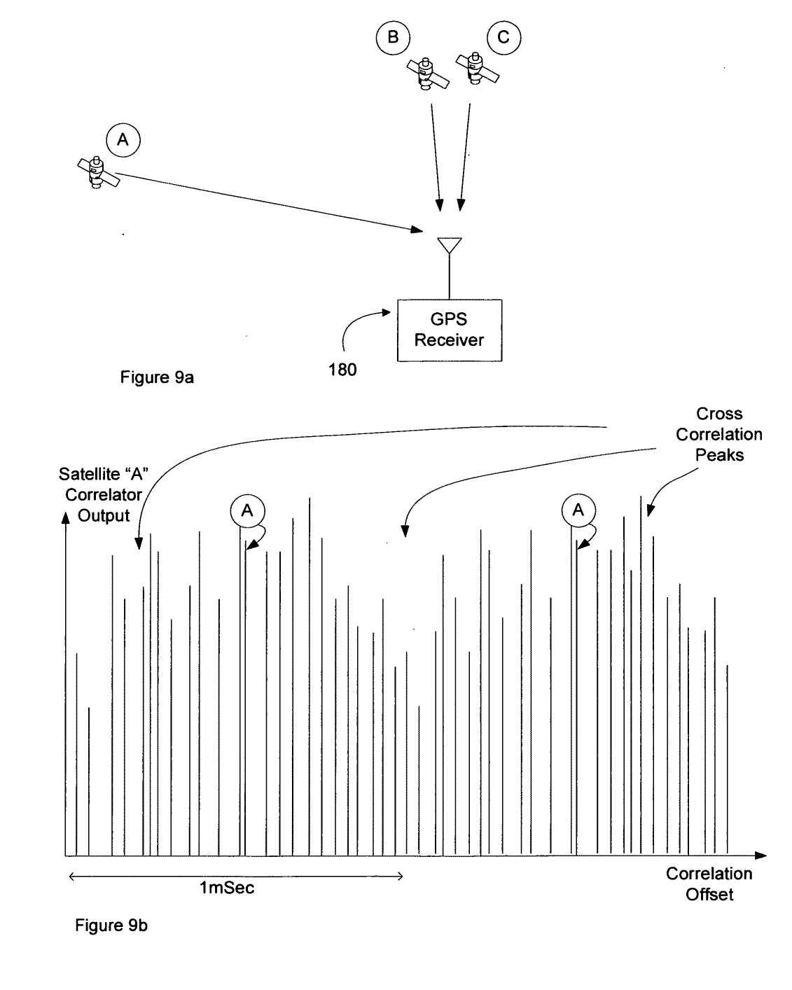

FIG. 10 describes the output of a correlator

FIG. 11 shows a block diagram of a satellite positioning system (SPS) employing the present invention

FIG. 12 shows a block diagram of a datagram processing facility employing the present invention

FIG. 13 describes one construction of a strong signal detector

FIG. 14 shows a block diagram of a datagram processing facility employing the present invention

FIG. 15 describes one construction of a strong signal suppression engine

FIG. 16 shows a block diagram of a perfect reference engine employing the present invention.

FIG. 17 shows a block diagram of a pseudo range engine utilizing perfect reference input.

FIG. 18 shows a block diagram of a pseudo range engine incorporating multi-path correction.

FIG. 19 shows a block diagram of a datagram processing facility employing the present invention

FIG. 20 shows a block diagram of a datagram processing facility employing the present invention

FIG. 21 shows a block diagram of a perfect reference engine incorporating carrier frequency and phase and channel compensation.

FIG. 22 shows a block diagram of a pseudo range engine utilizing perfect reference input with carrier frequency and phase and channel compensation.

FIG. 23 shows a block diagram of a pseudo range engine utilizing perfect reference input with carrier frequency and phase and channel compensation, and further incorporating multi-path correction.

### DETAILED DESCRIPTION OF THE INVENTION

In general, the object of the present invention is to provide methods and apparatus to increase the sensitivity of GPS receivers in order to provide for the reliable determination of location coordinates in indoor and urban canyon operation. To this end, novel signal processing techniques reducing the minimum signal strength required to acquire a satellite in indoor and urban canyon environments are disclosed. The use of multiple GPS sensors provides the conceptual framework for such techniques. In this context, GPS sensors are characterized as one of two types: target GPS sensors, whose location is to be determined; and reference GPS sensors, used in the derivation of a perfect reference signal critical to increasing the sensitivity of target GPS sensors.

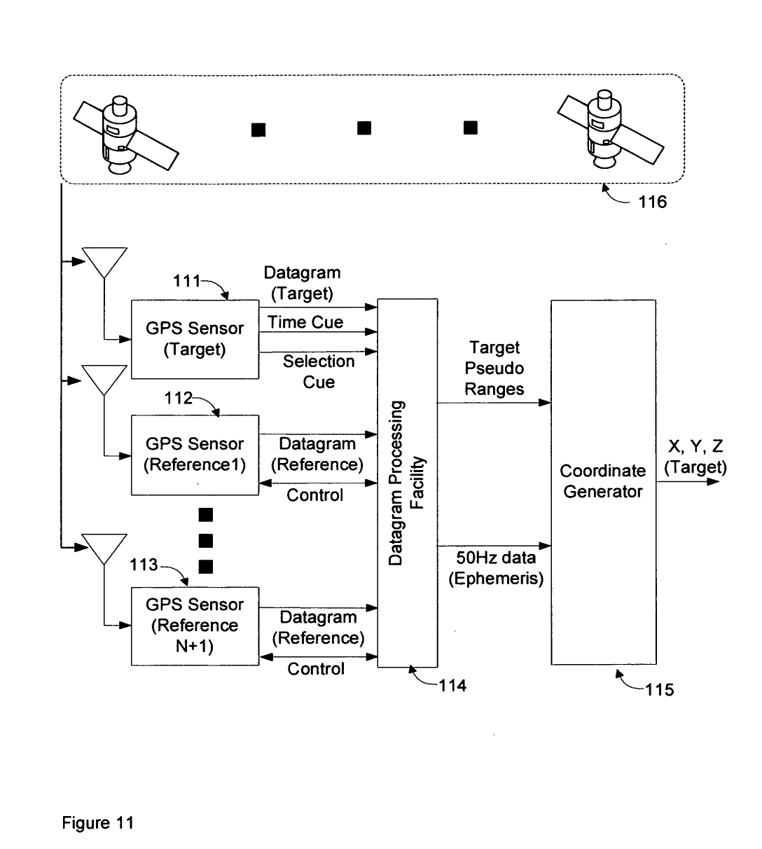

The reduction in the minimum signal strength required to acquire a satellite (characterized as an increase in receiver sensitivity) results from innovations in signal processing, enabled by the rearchitecting of prior art GPS receivers, as described in FIG. 11. The repartitioning of the basic functions—opening the signal processing platform to sophisticated techniques—enables the signal processing innovations essential to achieving the improvements in receive sensitivity required for reliable indoor and urban canyon operation.

As shown in FIG. 11, the invention postulates the embedding of simple target GPS sensors 111 with mobile devices that either host or serve as peripherals in location-based applications. These target GPS sensors receive and record signals transmitted by navigational satellites, and forward their recordings (datagrams) to a Datagram Processing Facility. The invention further postulates a set of one or more reference GPS sensors 112 and 113 embedded in devices deployed for the purpose of providing the Datagram Processing Facility reference datagrams useful in extracting the pseudo range information critical to the determination of the location of mobile devices.

The reference GPS sensors may be stationary or mobile. The presumption is, however, that they are stationary, in known locations, and positioned for unobstructed reception of satellite signals. Accordingly, positioning accuracy based on pseudo ranges measured at these reference GPS sensors can be further improved through a reconciliation of their measured location with their known location to correct for atmospheric effects, as is done with WAAS data.

The Datagram Processing Facility 114 processes datagrams from target and reference GPS sensors, in order to extract the information essential to determine the location of the target sensor. In general, one target datagram and one or more reference datagrams, overlapping at least partially in time, are used to determine the location. In the event there are multiple reference GPS sensors, the choice of which of the reference sensors/datagrams to use is made by the Datagram Processing Facility. To make constructive choices, the Datagram Processing Facility accepts selection cues from target GPS sensors (or their proxies) to minimize the remoteness of reference GPS sensors from target GPS sensors, and monitors and controls the reference sensors. To illustrate, a target GPS sensor may be embedded in a cellular phone, and so be able to provide, along with its datagram, the identity of the base station through which it is transmitting, or a location derived from the relative strength of signals from three nearby base stations. Such information, providing a rough estimate of the location of the target sensor, could prove useful in the selection of the reference sensors/datagrams to be used, in combination with the target datagram, to fix the location of the target sensor. The ability to control the reference sensors has numerous uses, from turning them off and on to extend battery life, to varying the datagram length to adapt to atmospheric conditions.

Outputs of the Datagram Processing Facility include 1) the target pseudo range to each of three (or four) acquired satellites, and 2) the 50 HZ data stream for each acquired satellite. These outputs are processed by coordinate generator 115 into target location coordinates formatted for location-based applications.

The physical implementation of the Datagram Processing Facility can take many forms. For location-based applications that are also networked applications, the most practical as well as the most cost-effective implementation takes the form of a server, or network of servers. In this case, the logical implementation of the functionality of the Datagram Processing Facility takes the form of software, accelerated as necessary by specialized hardware (e.g., FFT hardware).

Significant in this sensor-server partitioning is the fact that it enables a practical solution to the challenge of processing large datagrams—datagrams that span hundreds of PRN code intervals—which in turn enables signal processing gains that translate into a reduction in the minimum signal strength required to acquire a satellite. Further, this partitioning facilitates advanced signal processing techniques such as perfect reference generation. Perfect reference generation is a novel technique for optimizing the derivation of pseudo ranges from datagrams recorded at target GPS sensors, whether by correlation or by equalization techniques. The perfect reference is typically generated from one or more of the datagrams recorded by reference GPS sensors, the reference GPS sensors/datagrams having been selected to optimize the efficiency and efficacy of the perfect reference generation process. Alternatively, the perfect reference may be generated from one or more of the satellite-specific datagrams generated by a Strong Signal Suppression Engine (see below), to optimize the efficiency and efficacy of the perfect reference generation process.

### Strong Signal Suppression

To the extent that the satellites electronically visible to target GPS sensors inside commercial buildings are likely to be near the horizon, and at the same time these satellites may be electronically invisible to reference GPS sensors, owing to the interference of stronger signals from overhead satellites, techniques for reducing the minimum signal strength required by GPS Satellite Positioning Systems (SPS) to acquire and accurately track satellites near the horizon are critical. The use of multiple reference GPS sensors, each incorporating an antenna and a front end, provides a conceptual framework for such techniques.

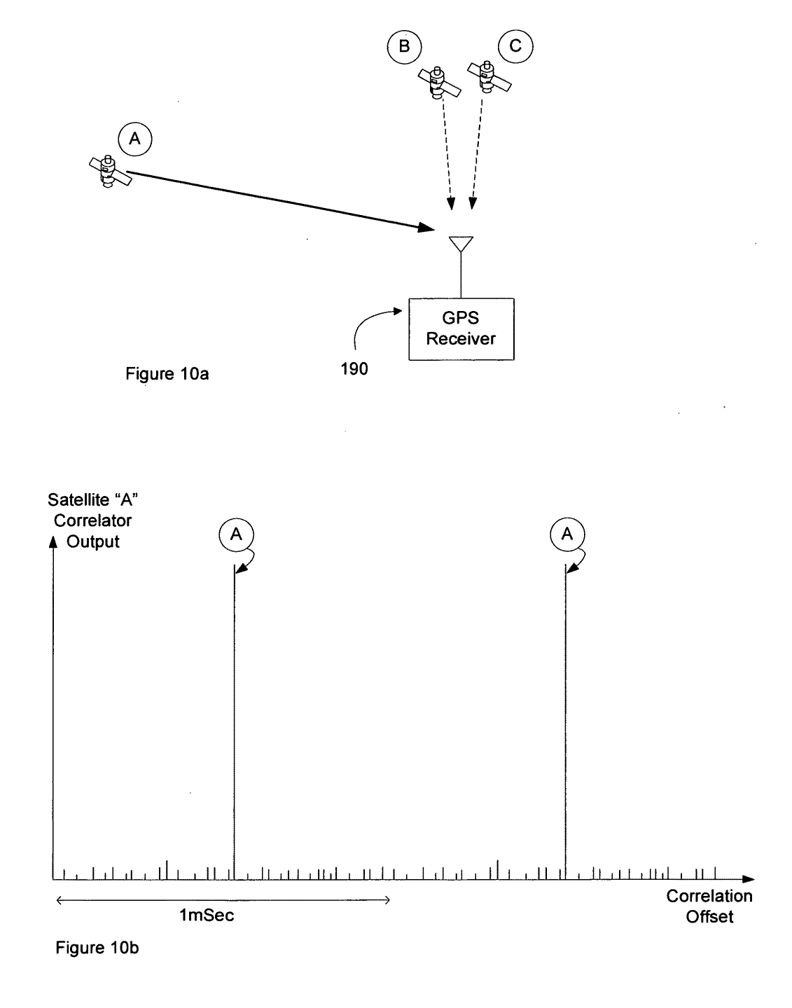

The techniques disclosed herein address the strong signal interference problem by selecting/synthesizing satellite-specific signals, each with the strongest potentially-interfering signals suppressed. (By suppressing the strong potentially-interfering signals, the prominent cross correlation peaks are suppressed, as shown in FIG. 10.) The techniques to select/synthesize satellite-specific I/F signals from composite GPS satellite signals recorded at reference GPS sensors vary with the type of antenna deployed with the reference GPS sensors. The antennae may be uni-directional or omni-directional or a mix of the two. For the sake of brevity, this disclosure focuses on homogeneous GPS sensor/antenna deployments; that is, SPS deploying either uni-directional or omni-directional antennae. SPS deploying a mix of uni-directional and omni-directional antennae are rational systems, implemented straightforwardly using the teachings of this disclosure.

In the case that uni-directional antennae are deployed, the invention postulates a hemisphere (with its origin in the neighborhood of the target receiver) partitioned into N+1 elements, corresponding to the directional attributes of N+1 antennae deployed with N+1 reference GPS sensors. Each of the reference GPS sensors down converts the (composite) satellite signal, yielding the I/F signal (bit stream) appropriate to the acquisition of the satellite or satellites within the field of view of its directional antenna. To illustrate one example of hemisphere partitioning, consider 9 GPS sensors/antennae—2 pointed North, 2 pointed East, 2 pointed South, 2 pointed West, and one pointed upward—with each pair able to “see” 45 degrees to either side of its horizontal aiming point. If each pair is further constructed to cover complementary elevations (e.g., 0-30 degrees and 30-60 degrees), the hemisphere is covered completely. This partitioning provides 4 GPS sensors for near-horizon satellites, and 5 for overhead satellites. With its knowledge of the approximate locations of all the hemispherically visible (i.e., likely to be decodable based on time and trajectory) satellites at all times, the SPS system maintains an up-to-date table of available satellites with their corresponding GPS sensors. (Note that this mapping need not be 1 for 1, as the partitioning of the hemisphere may not preclude the presence of multiple satellites within the field of view of a single GPS sensor.)

In the case that omni-directional antennae are deployed, the invention postulates the capability to attenuate at least N strong satellite signals to enable the acquisition of a weak satellite signal. Accordingly, N+1 reference GPS sensors are deployed. Each of the reference GPS sensors down converts the composite satellite signal, yielding an I/F signal (bit stream) which, together with the I/F signals from the remaining N reference GPS sensors, enables the synthesis of I/F signal(s) appropriate to the acquisition of weak satellite signal(s). The synthesis involves the use of novel signal processing techniques to realize the I/F signal(s) corresponding to one or more designated satellites, each with N of the strongest potentially-interfering satellite signals suppressed. These techniques are embodied within a subsystem characterized as a Strong Signal Suppression Engine.

### The Datagram Processing Facility

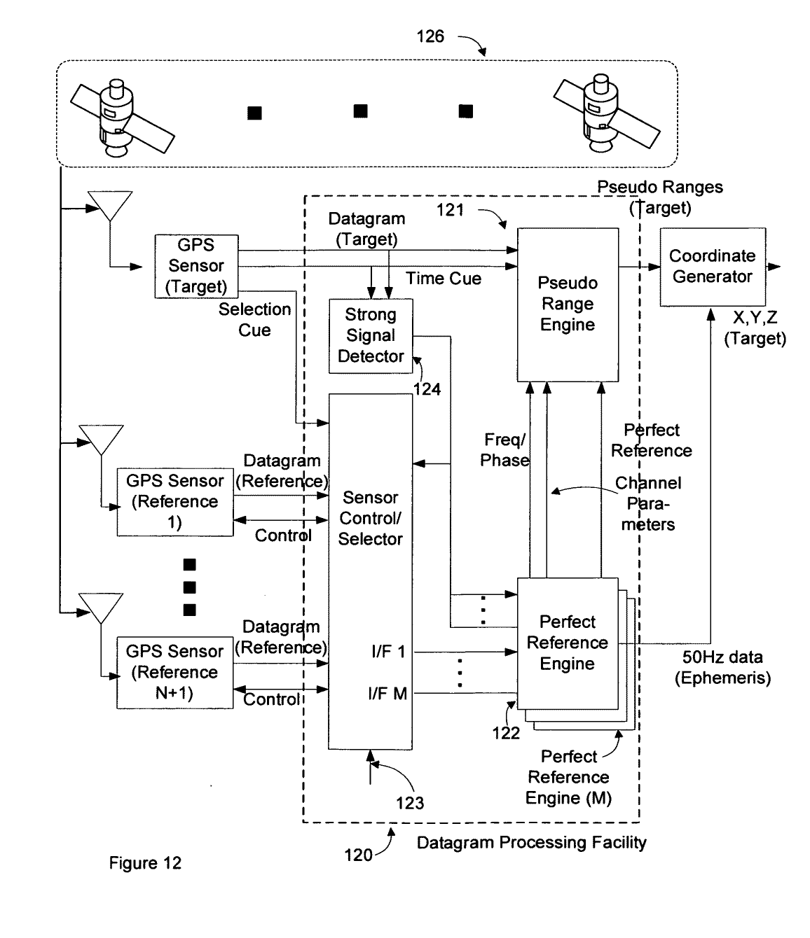

FIG. 12 describes a Datagram Processing Facility. The principle elements are 1) the Pseudo Range Engine 121, 2) the Perfect Reference Engine 122, 3) the Sensor Controller/Selector 123, and 4) the Strong Signal Detector 124.

The Strong Signal Detector 124 has two major functions. The first, strong signal detection function, identifies (on the basis of a minimal datagram) the signals/satellites with the greatest potential for acquisition, based on their signal strength. This information is used by the Sensor Controller/Selector 123 to select the set of reference GPS sensors/datagrams with the greatest potential to optimize the efficiency and efficacy of the perfect reference generation process. The second function of the Strong Signal Detector 124 is to provide additional information characterizing the signals from each of the satellites identified as having the greatest potential for acquisition. This information is used by the Perfect Reference Engine 122 (and by the Strong Signal Suppression Engine, if present) to configure/initialize these engines to optimize the efficiency and efficacy of the perfect reference generation process.

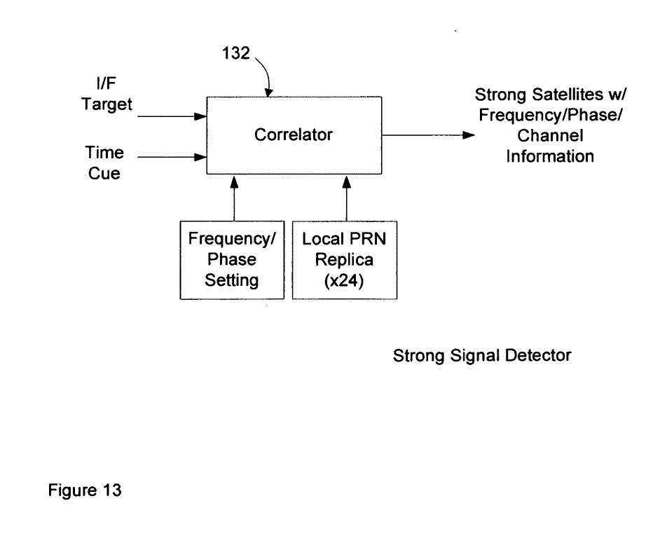

FIG. 13 describes one embodiment of the Strong Signal Detector of FIG. 12. Strong Signal Detector 130 implements a simple correlation process, wherein the first (say) 20 PRN code intervals of the target datagram is processed (Correlator 132) to determine which, if any, satellites are electronically visible, and to characterize their signals. The use of a correlator, has the benefit of providing implicitly, a particularly useful metric for the strength of each of the detected satellite signals; namely, the correlation peak/average ratio. This metric enables the rank ordering of signals/satellites by strength. It further enables the definition of a strong signal selection threshold, with operational as well as performance implications. Applying specified “electronic visibility” criteria, Strong Signal Detector 124, provides the identification and characterization of the strongest satellite signals at the target.

The Sensor Controller/Selector 123 has two major functions. The control function ensures that the reference GPS sensor or sensors are on-line and performing, delivering reference datagrams suitable for use in fixing the locations of target GPS sensors. Where a set of reference sensors includes mobile sensors, the control function includes turning them on and off to extend battery life, and to initiate a service call to replace a weak battery.

The selection function determines the choice (if there is one) of reference GPS sensors/datagrams to be used in the derivation of the perfect reference to be used in extracting the location implicit in each target datagram as received at the Datagram Processing Facility 120. In general, the selection is made from reference GPS sensors in the neighborhood of the target receiver, assuming a location cue, such as the approximate location obtained by analyzing the relative signal strengths, measured at the target GPS sensor, to nearby cellular base stations, is available. In the case where the SPS is constructed with uni-directional antennae, the selection process is driven by the hemispheric mapping of satellites identified by the Strong Signal Detector 124 as being electronically visible to the target sensor (see below).

The Datagram Processing Facility of FIG. 12 supports an SPS constructed with uni-directional antennae. In this case, the identities of the satellites electronically visible to the target GPS sensor, generated by Strong Signal Detector 124, are used by Sensor Controller/Selector 123, with its up-to-the-minute mapping of satellites to reference GPS sensors, to configure its MUX. Accordingly, the outputs of the reference GPS sensors are multiplexed to produce, simultaneously, the I/F signals for each of M satellites electronically visible to the target GPS receiver. The presumption here is that Strong Signal Detector 124 has identified at least M strong signals. Failing this assumption, Sensor Controller/Selector 123 configures the MUX to produce, in addition to the I/F signals for each of the m satellites identified by Strong Signal Detector 124, the I/F signals for each of M-m complementary satellites hemispherically visible to the target GPS receiver. It is further presumed that a bank of at least M Perfect Reference Engines is available to process the simultaneously presented I/F signals.

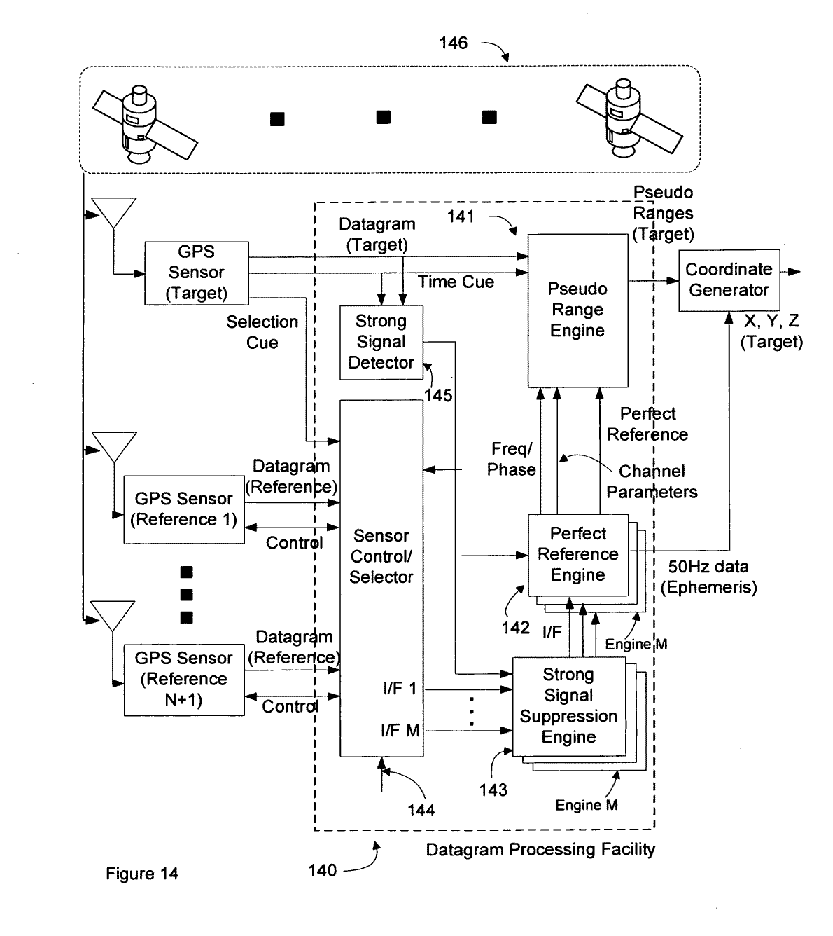

The Datagram Processing Facility of FIG. 14 supports an SPS constructed with omni-directional antennae. The Pseudo Range Engine, Perfect Reference Engine and Strong Signal Detector of Datagram Processing Facility 140 are functionally identical to their counterpart components in Datagram Processing Facility 120. The difference is reflected in the incorporation, between the Sensor Controller/Selector 144 and Perfect Reference Engine 142, of the Strong Signal Suppression Engine 143. In this case, the Sensor Controller/Selector 144 acts primarily on the location cue to configure the MUX.

The identity and characteristics of the satellite signals electronically visible to the target GPS sensor generated by Strong Signal Detector 145 are used to configure/initialize the Strong Signal Suppression Engine 143 and the Perfect Reference Engine 142. Strong Signal Suppression Engine 143 produces, simultaneously, the I/F signals for each of M satellites electronically visible to the target GPS receiver, each with at least N of the strongest potentially-interfering satellite signals suppressed. The presumption here is that Strong Signal Detector 145 has identified at least M strong signals. Failing this assumption, Strong Signal Suppression Engine 143 produces, in addition to the I/F signals for each of the m satellites identified by Strong Signal Detector 145, the I/F signals for each of M-m complementary satellites hemispherically visible to the target GPS receiver, each with at least N of the strongest potentially-interfering satellite signals suppressed. It is further presumed that a bank of at least M Perfect Reference Engines is available to process the simultaneously presented I/F signals.

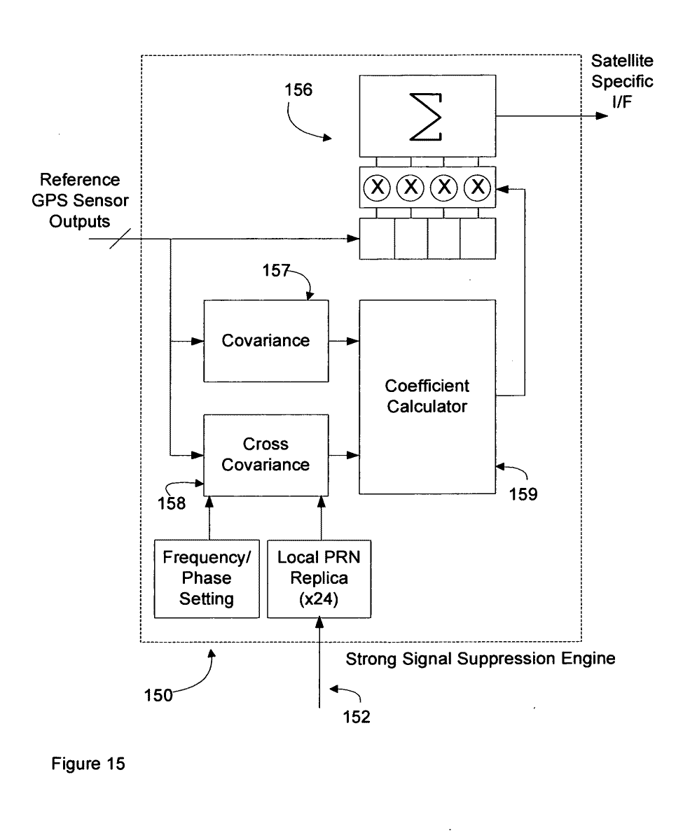

The Strong Signal Suppression Engine incorporates one or more I/F signal synthesis engines together with the logic to control them. The control logic serves to initialize the synthesis engine(s) for the synthesis of the desired I/F signal(s). An example of one such engine is described in FIG. 15.

With input from N+1 reference GPS sensors, Strong Signal Suppression Engine 150 synthesizes a single I/F signal corresponding to the satellite-specific PRN code provided. The I/F signal is synthesized as a weighted sum of the N+1 reference GPS sensor inputs. The weighting coefficients are generated from a covariance matrix common for all satellites and a cross covariance matrix for each desired signal. Where it is desired to simultaneously synthesize M I/F signals, this engine could be replicated M times. Alternatively, a multi-output equivalent might be employed.

The Perfect Reference Engine 122 receives selected reference datagrams from the Sensor Controller/Selector 123 and processes them to obtain—in addition to the perfect reference—the 50 Hz data stream (carrying ephemeris data, etc.) and frequency, phase, and channel characterization parameters. The frequency, phase, and channel characterization parameters together with the perfect reference are used by the Pseudo Range Engine 121 to extract target pseudo ranges from the target datagram. These target pseudo ranges, together with the associated 50 Hz data streams are used by the Coordinate Generator to derive the coordinates of the target for use by location-based applications.

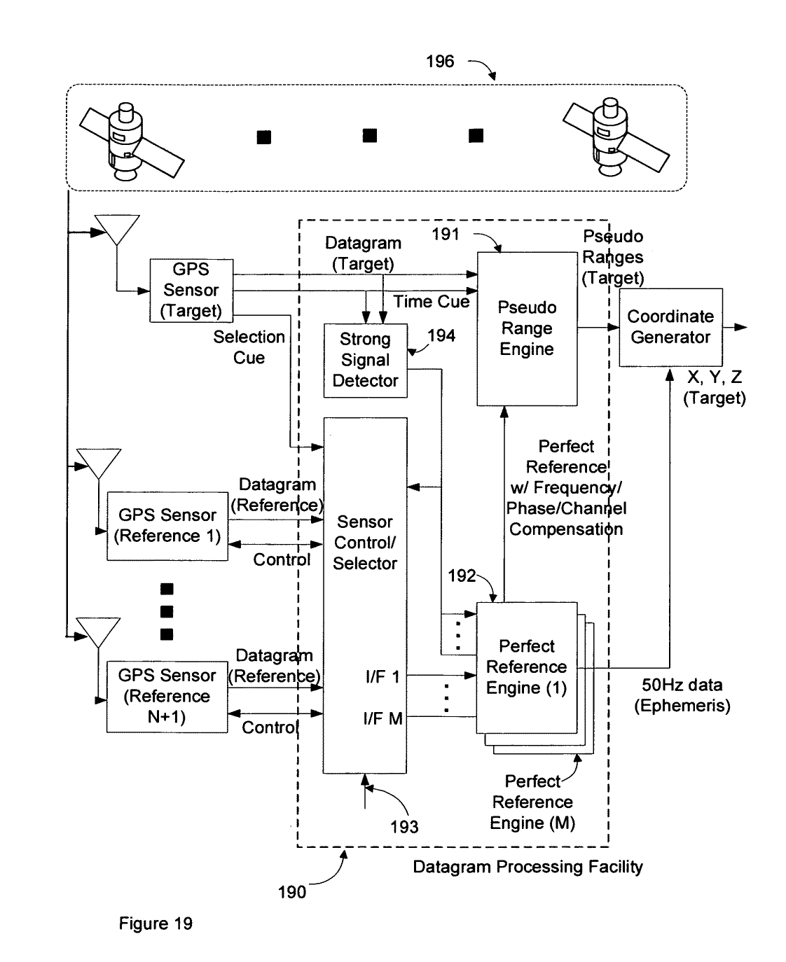

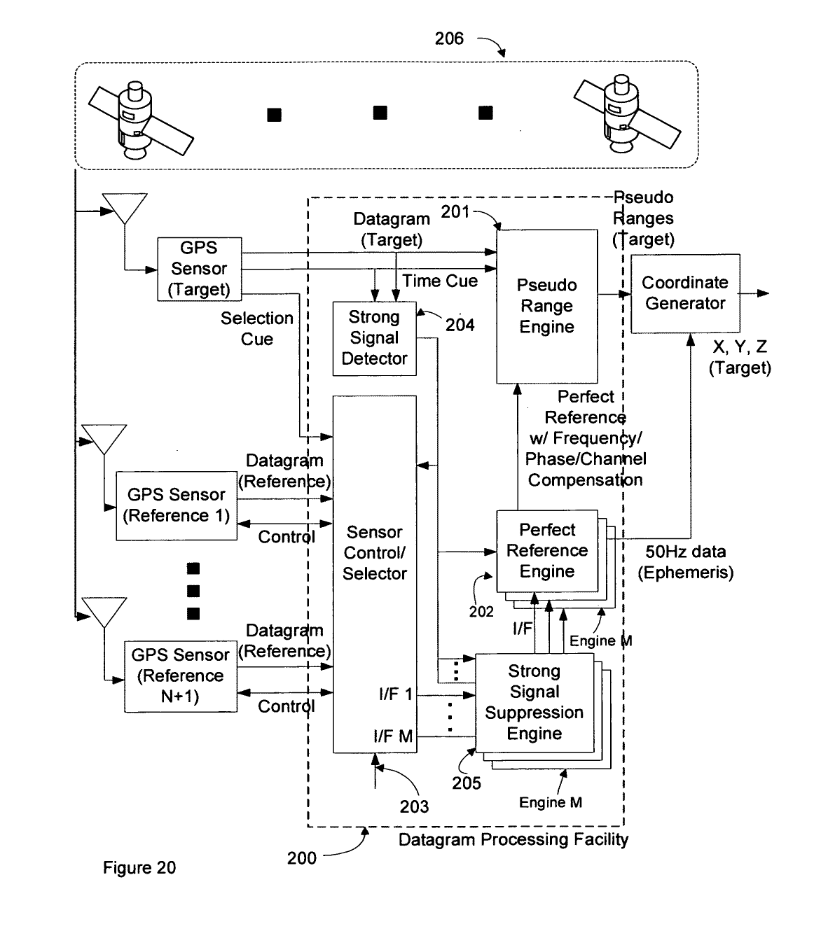

In other embodiments of the Datagram Processing Facility (FIGS. 19 and 20), the carrier frequency and phase offsets and the channel characterization parameters are applied within the Perfect Reference Engine 192 and 202 to generate a perfect reference, pre-conditioned to allow for the trivial extraction of target pseudo ranges from target datagrams.

### The Perfect Reference Engine

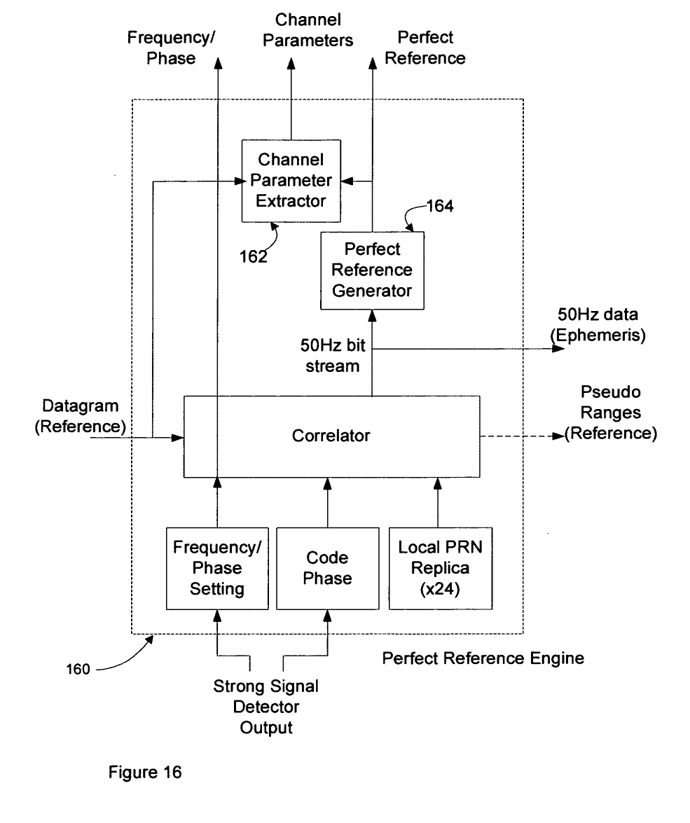

At one level, the Perfect Reference Engine 160 (FIG. 16) looks like a prior art GPS receiver with added functionality. The implementation is different in several respects, the primary difference relating to the size of the datagrams processed. Because the datagrams are large, to enable the acquisition of buried satellite signals, the correlation is lengthened; to minimize the problems introduced by local oscillator drift, reference GPS sensors are implemented with high quality oscillators. The time required to extract the reference pseudo ranges is minimized by careful coding of the correlation computation and by intelligently implementing the frequency search.

The remaining blocks in FIG. 16—the optional Channel Parameter Extractor 162 and the Perfect Reference Generator 164—require little elaboration. The Channel Parameter Extractor 162 simply compares the reference datagram with the perfect reference to extract channel characterization parameters for use by the Pseudo Range Engine. Channel parameter extraction techniques are likewise well known in the art. The function of the Perfect Reference Generator 164 follows trivially from the definition of the perfect reference; namely, that it is a reconstruction of the transmitted signal, based on the analysis of a large datagram, and timed precisely, to enable the determination of the location coordinates of a target GPS sensor from pseudo ranges to three (or four) of the navigation satellites. Accordingly, the Perfect Reference Generator 164 involves simply synching up the local PRN code replica with the 50 Hz bit stream and combining the two.

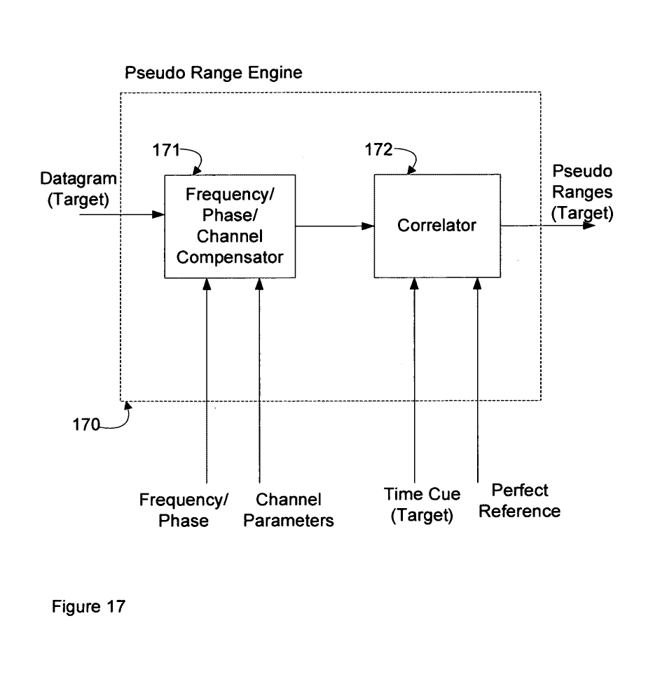

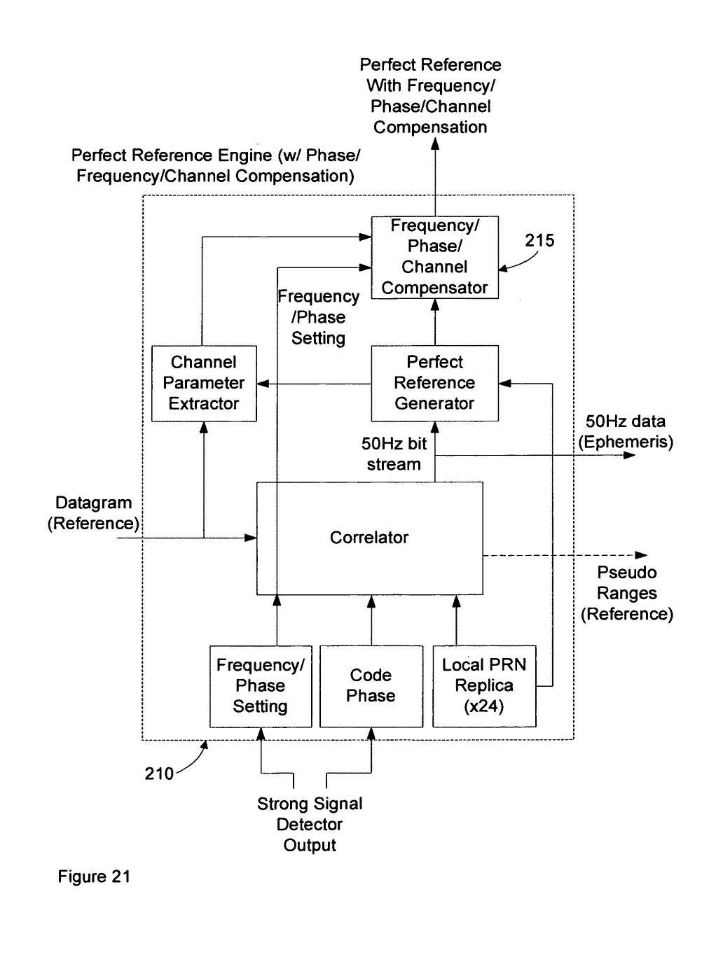

In a second embodiment of the Perfect Reference Engine (FIG. 21), the frequency, phase, and channel characterization parameters are applied within the Perfect Reference Engine 210 (using Frequency/Phase/Channel Compensator 215), pre-conditioning the perfect reference to enable the trivial extraction of target pseudo ranges from target datagrams (see FIG. 17).

### The Pseudo Range Engine

As shown in FIG. 17, the availability of a perfect reference dramatically simplifies the derivation of target pseudo ranges from target datagrams. All that remains after compensating for frequency, phase, and channel effects (the function of Frequency/Phase/Channel Compensator 171) is a simple correlation process, wherein the compensated target datagram is correlated by Correlator 172 with the perfect reference to extract the target pseudo range. The use of a correlator, has the benefit of providing implicitly, a particularly useful metric for the quality of the pseudo range estimate; namely, the correlation peak/average ratio.

This metric allows for the optimal selection of the three (or four) pseudo ranges required to generate the location coordinates of the target GPS sensor. More importantly, it allows for the definition of a usability threshold for pseudo ranges, with operational as well as performance implications. To illustrate, the Perfect Reference Engine 160 may for practical reasons, compute perfect references in sets of say four. Failing to extract three (or four) usable pseudo ranges using a first set of perfect references, the Pseudo Range Engine 170 might then request (from Perfect Reference Engine 160) a second set of perfect ranges, and perhaps, a third, until it determines that a reliable position fix cannot be extracted from the target datagram in question.

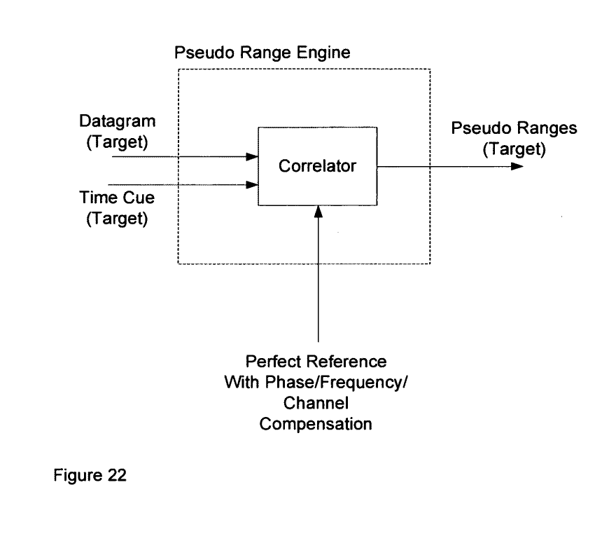

A second embodiment of the Pseudo Range Engine (FIG. 22), which employs a compensated perfect reference, simplifies Pseudo Range Engine 170 by eliminating the Frequency/Phase/Channel Compensator 171, albeit at the expense of adding complexity (Frequency/Phase/Channel Compensator 215) to Perfect Reference Engine 160.

A Pseudo Range Engine with Multi-Path Correction

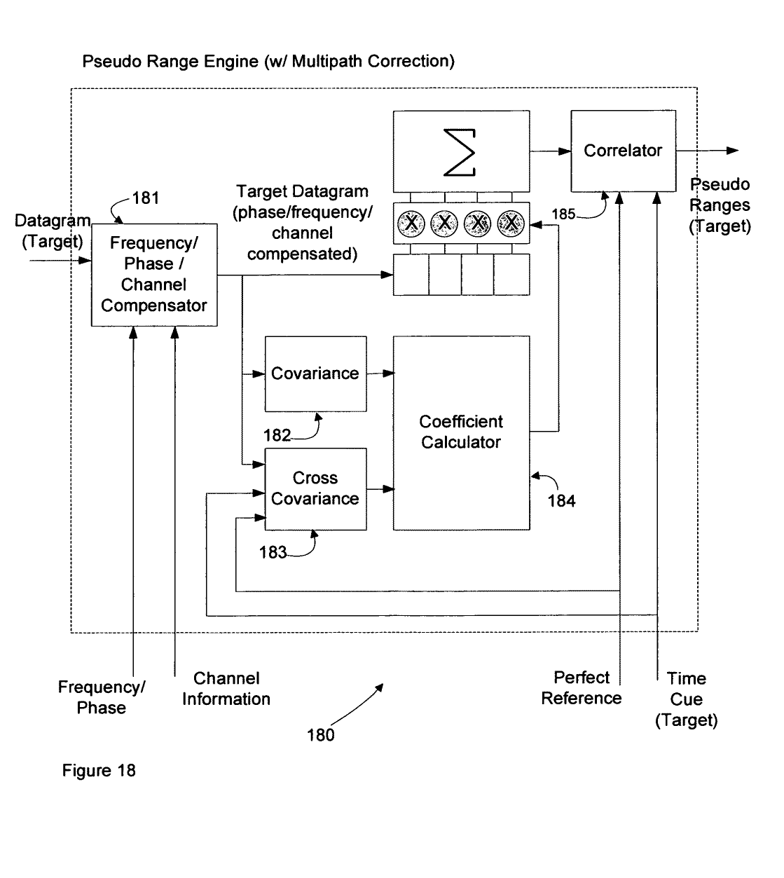

FIG. 18 describes Pseudo Range Engine 180, with the capability to isolate and recombine multi-path signals implicit in target datagrams. As with the basic Pseudo Range Engine 170, the target datagram is first compensated for frequency, phase, and channel effects using Frequency/Phase/Channel Compensator 181. The resulting datagram is then reconstituted via a weighted summing process, where the weighting coefficients are derived through a process proceeding with the computation of the covariance (Covariance block 182) of the compensated target datagram and the cross-covariance (Cross-Covariance block 183) of the compensated target datagram with the perfect reference. The weighting coefficients follow by computing the product of the inverse of the covariance matrix and the cross-covariance (Coefficient Calculator 184).

The multi-path-corrected target datagram is then correlated with the perfect reference using Correlator 185, a correlator identical to that of the basic Pseudo Range Engine 170, to extract target pseudo ranges and cull from the results, the highest quality three (or four) pseudo range for the generation of a reliable position fix.

The choice of a correlator to extract the target pseudo range from the multi-path-corrected target datagram creates the potential of further enhancement of the quality of the pseudo range estimate through the simultaneous optimization of the multi-path coefficients and the quality metric. In this case, all that is required is to include the coefficient computation within the correlation loop. The covariance matrix would be computed just once; the rest of the computation would be repeated with each iteration of the correlation process. This procedure could be reserved for those occasions when the serialization of weighted summation and correlation fail to provide the requisite number of usable pseudo ranges.

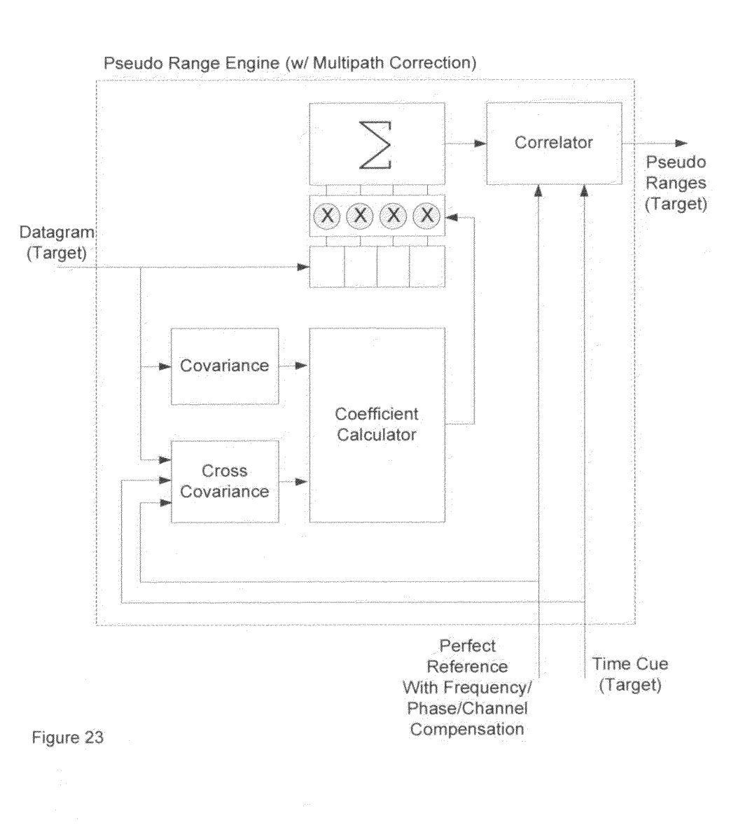

A second embodiment of the Pseudo Range Engine with Multi-Path Correction (FIG. 23) simplifies Pseudo Range Engine 180, albeit at the expense of adding complexity to Perfect Reference Engine 160.

In practice, the Datagram Processing Facility is likely to be supported by an operating system such as Windows, UNIX, LINUX, etc. These operating systems will provide much of the process scheduling and table management essential for the efficient operation of the subsystems (of the Datagram Processing Facility) and interactions between the subsystems.

We claim:

1. A method for measuring the pseudo range from a target GPS sensor to a designated navigational satellite, for use in a satellite positioning system (SPS), said method comprising:
receiving at the target GPS sensor a target portion of the signal transmitted by the designated navigational satellite;
recording said target portion of the transmitted signal, the recording hereinafter referred to as the target datagram;
deriving the pseudo range from the target datagram using a signal processing technique employing a perfect reference, wherein:
said perfect reference is generated from one or more reference datagrams received and recorded at one or more reference GPS sensors; and wherein:
the target datagram and the reference datagram (or datagrams) overlap at least partially in time.

2. The method of claim 1, wherein the target GPS sensor is embedded in a mobile SPS receiver.

3. The method of claim 2, wherein the target datagram is transmitted via an SPS base station to a datagram processing facility, for the purpose of measuring the pseudo range from the target GPS sensor to the designated navigational satellite.

4. The method of claim 3, wherein the datagram processing facility is incorporated within the SPS base station.

5. A system for measuring the pseudo range from a target GPS sensor to a designated navigational satellite, for use in a satellite positioning system (SPS), said system comprising:
target and one or more reference GPS sensors for receiving and recording target and one or more reference portions of the signal transmitted by the designated navigational satellite, the recordings hereinafter referred to as the target and reference datagrams;
means for transmitting the target and reference datagrams to a datagram processing facility; and
a datagram processing facility wherein:
a perfect reference is generated from the one or more reference datagrams, and wherein:
the pseudo range from the target GPS sensor to the designated navigational satellite is derived from the target datagram using a signal processing technique employing the perfect reference.

6. The system of claim 5, wherein the one or more reference GPS sensors are members of a set of one or more GPS sensors designated for the purpose of perfect reference generation.

7. The system of claim 6, wherein the GPS sensor or sensors comprising said set are stationary.

8. The system of claim 5, wherein the signal processing technique provides for recombination of multi-path GPS signals.

9. A datagram processing facility for extracting the pseudo range from a target GPS sensor to a designated navigational satellite from a datagram originating with said target GPS sensor, said facility comprising:
a pseudo range engine for deriving a pseudo range from said datagram originating with said target GPS sensor, the derivation accomplished with the aid of a perfect reference, and
a perfect reference engine for generating a perfect reference from one or more datagrams originating with one or more reference GPS sensors, designated for the purpose of perfect reference generation.

10. The facility of claim 9, further comprising means to choose (when there is a choice) which of the datagrams originating with the one or more reference GPS sensors designated for the purpose of perfect reference generation shall be used to generate the perfect reference for the derivation of pseudo range from the datagram originating with said target GPS sensor, the location of which is to be determined.

11. The facility of claim 10, wherein the choice is made to minimize the estimated distance between the target GPS sensor and the one or more reference GPS sensors designated for perfect reference generation.

12. The facility of claim 11, wherein the choice is implemented by searching a table of the locations of the reference GPS sensors designated for the purpose of perfect reference generation to determine which is/are closest to an estimate of the location of the target GPS sensor, said estimate obtained by analyzing the relative signal strengths, measured at the target GPS sensor, to nearby cellular base stations.

13. A perfect reference engine for generating a perfect reference to facilitate the derivation of a target pseudo range from a datagram originating with a target GPS sensor, said engine comprising:
local replicas of the PRN codes for the GPS satellites;
correlation means for recovering, from a large reference datagram, through iteration over frequency and PRN code phase, the (PRN code specific) 50 Hz bit stream or bit streams implicit in said datagram;
correlation means for deriving, from a large reference datagram, through iteration over frequency and PRN code phase, the (PRN code specific) reference pseudo range or pseudo ranges implicit in said datagram; and
means for reconstructing for each satellite, the transmitted signal, using the recovered satellite-specific 50 Hz bit stream and PRN code replica.

14. The perfect reference engine of claim 13, further comprising correlation means for grading the quality of the (PRN code specific) reference pseudo ranges extracted from said large reference datagram.

15. A method for generating a perfect reference to facilitate the derivation of a target pseudo range from a datagram originating with a target GPS sensor, said method comprising:
PRN code phase iteration over a constellation of satellites;
frequency iteration over a range of frequencies;
for each frequency and PRN code phase, correlation of a large satellite-specific reference datagram with one or more PRN code replicas to derive:
the (PRN code specific) 50 Hz bit stream or bit streams implicit in said large reference datagram, and
the (PRN code specific) reference pseudo range or pseudo ranges implicit in said large satellite-specific reference datagram; and
combination of each 50 Hz bit stream with its corresponding PRN code replica to reconstruct the transmitted satellite-specific signal.

16. The method of claim 15, wherein the (PRN code specific) reference pseudo range is derived together with a grade of the quality of said reference pseudo range.
